(19) United States
(12) Patent Application Publication
(10) Pub. No.: US 2016/0147335 A1
(43) Pub. Date: May 26, 2016

(54) SHEET FOR MANUFACTURING SENSOR SHEET, METHOD FOR MANUFACTURING SHEET FOR MANUFACTURING SENSOR SHEET, SENSOR SHEET FOR TOUCH PAD, AND METHOD FOR MANUFACTURING SENSOR SHEET FOR TOUCH PAD

(71) Applicant: SHIN-ETSU POLYMER CO., LTD., Tokyo (JP)

(72) Inventors: Koji Nishizawa, Saitama-Shi (JP); Hiroto Komatsu, Saitama-Shi (JP); Shinji Hotta, Saitama-Shi (JP)

(21) Appl. No.: 14/782,744

(22) PCT Filed: Apr. 10, 2014
(86) PCT No.: PCT/JP2014/060401

§ 371 Date: Dec. 7, 2015

(30) Foreign Application Priority Data
Apr. 12, 2013 (JP) 2013-084158
Mar. 25, 2014 (JP) 2014-061768

(51) Int. Cl. G06F 3/044; C23F 1/00

(52) U.S. Cl. CPC G06F 3/044; C23F 1/00; G06F 2203/04103; G06F 2203/04111

(57) ABSTRACT

A sensor sheet-producing sheet of the present invention includes a base layer; and a metal deposition layer having a thickness of 0.01 to 1.0 μm which is formed on one surface of the base layer. A method for manufacturing a sensor sheet-producing sheet of the present invention includes a deposition step in which a metal deposition layer having a thickness of 0.01 to 1.0 μm is deposited on one surface of a base layer. In the method for manufacturing a sensor sheet-producing sheet of the present invention, it is preferable that the deposition be vacuum deposition.

### TECHNICAL FIELD

The present invention relates to a sensor sheet-producing sheet, a method for manufacturing a sensor sheet-producing sheet, a sensor sheet for a touch pad, and a method for manufacturing a sensor sheet for a touch pad.

Priority is claimed on Japanese Patent Application No. 2013-084158, filed Apr. 12, 2013 and Japanese Patent Application No. 2014-061768, filed Mar. 25, 2014, the contents of which are incorporated herein by reference.

### BACKGROUND ART

In a note type personal computer or the like, a touch pad using a capacitance touch sensor is prepared as an input device which moves a pointer in a display screen. As a touch sensor, a sensor in which an X direction electrode, a Y direction electrode, a leading wiring, and a terminal for external connection are formed on a base layer is widely used. Herein, the X direction electrode is an electrode formed along an X direction, the Y direction electrode is an electrode formed along a Y direction, and the leading wiring is a wiring for connecting the electrodes and the terminal for external connection to each other.

As a method for forming the X direction electrode, the Y direction electrode, and the leading wiring, a method of performing screen printing of a conductive paste with a pattern in which the X direction electrode, the Y-direction electrode, and the leading wiring are formed is known (Patent Literature 1). In addition, a method for laminating metal foil on a base layer and etching the metal foil such that the X direction electrode, the Y direction electrode, and the leading wiring are formed is known (Patent Literature 2).

### CITATION LIST

### Patent Literature

### [Patent Literature 1]

Japanese Unexamined Patent Application, First Publication No. 2011-216061

### [Patent Literature 2]

Japanese Unexamined Patent Application, First Publication No. 2010-049618

### SUMMARY OF INVENTION

### Technical Problem

In recent years, the area of a touch pad of a note-type personal computer has increased. When the area of a touch pad increases, the number of electrodes increases and thus the number of leading wirings also increases. However, enlarging the area of a base material to increase the number of leading wirings is not desirable from the viewpoint of realising a large-scale touch pad and incurs extra cost caused by increasing the width of an outer peripheral portion (may be referred to as a “frame portion”). Therefore, a technology to enlarge a region for electrodes by narrowing intervals between the adjacent leading wirings is required, but in the methods disclosed in Patent Literatures 1 and 2, it is difficult to narrow the intervals between the adjacent leading wirings.

In addition, in order to fill an inner portion of a housing of a computer with components in a compact manner, the sensor sheet may be overlapped on a portion in which the electrodes are formed, by folding back a portion in which the terminal for external connection is formed (may be referred to as a “tail portion”). However, the leading wirings formed by the methods disclosed in Patent Literatures 1 and 2 have low bending resistance and disconnection occurs when bending is performed.

An object of the invention is to provide a sheet for manufacturing a sensor sheet in which intervals between leading wirings can be narrowed when forming the leading wirings by etching and which has high bending resistance and is low in cost, and a method for manufacturing a sensor sheet-producing sheet.

In addition, another object of the invention is to provide a sensor sheet for a touch pad in which intervals between leading wirings can be narrowed and which has high bending resistance and is low in cost, and a method for manufacturing a sensor sheet for a touch pad.

### Solution to Problem

Through investigation, the inventors have found that it is difficult to narrow intervals between adjacent leading wirings in the methods disclosed in Patent Literatures 1 and 2, due to a great thickness of a metal layer formed by printing of metal foil or a conductive paste. Therefore, the inventors investigated the formation of a thin metal layer and completed the invention of a sensor sheet-producing sheet, a method for manufacturing a sensor sheet-producing sheet, a sensor sheet for a touch pad, and a method for manufacturing a sensor sheet for a touch pad which will be described below.

The invention includes the following aspects.

[1] A sensor sheet-producing sheet including:

a base layer; and

a metal deposition layer having a thickness of 0.01 to 1.0 μm which is formed on one surface of the base layer.

[2] A method for manufacturing a sensor sheet-producing sheet, including: a deposition step in which a metal deposition layer having a thickness of 0.01 to 1.0 μm is deposited on one surface of a base layer.
[3] The method for manufacturing a sensor sheet-producing sheet according to [2], wherein the deposition is vacuum deposition.
[4] A sensor sheet for a touch pad comprising:

a base layer;

an X coordinate detection electrode wiring;

a Y coordinate detection electrode wiring;

a plurality of leading wirings;

a first insulating layer;

jumper lines; and

a second insulating layer, wherein

the X coordinate detection electrode wiring, the Y coordinate detection electrode wiring, and the leading wirings are formed on one surface of the base layer, each thickness being within a range from 0.01 to 1.0 μm,

the X coordinate detection electrode wiring has a wiring pattern which is formed of Y direction electrode portions in a plurality of columns along a Y direction and in which the Y direction electrode portions of the respective columns are comprised of an elongated electrode portion which is not divided,

the Y coordinate detection electrode wiring has a wiring pattern which is formed of X direction electrode portions in a plurality of columns along the X direction and in which the X direction electrode portions of the respective columns are comprised of a plurality of independent electrode portions which are divided from each other,

an interval between the adjacent leading wirings is within a range from 20 to 100 μm,

the first insulating layer is an insulating resin-containing layer having a thickness of 0.5 to 25 μm which is formed on the surfaces of the base layer, the X coordinate detection electrode wiring, the Y coordinate detection electrode wiring, and the leading wirings, through holes exposing a part of the respective independent electrode portions of the Y coordinate detection electrode wiring being formed in the first insulating layer,

the jumper lines are formed on the surface of the first insulating layer and in the through holes such that the independent electrode portions constituting the X direction electrode portion of the respective columns are electrically connected to each other, and

the second insulating layer is formed on the surfaces of the jumper lines and the first insulating layer.

[5] A sensor sheet for a touch pad comprising:

a base layer;

an X coordinate detection electrode wiring;

a Y coordinate detection electrode wiring;

a plurality of leading wirings;

a first insulating layer;

jumper lines; and

a second insulating layer, wherein

the X coordinate detection electrode wiring, the Y coordinate detection electrode wiring, and the leading wirings are formed on one surface of the base layer, each thickness being within a range from 0.01 to 1.0 μm,

the X coordinate detection electrode wiring has a wiring pattern which is formed of Y direction electrode portions in a plurality of columns along a Y direction and in which the Y direction electrode portions of the respective columns are comprised of a plurality of independent electrode portions which are divided from each other,

the Y coordinate detection electrode wiring has a wiring pattern which is formed of X direction electrode portions in a plurality of columns along the X direction and in which the X direction electrode portions of the respective columns are comprised of an elongated electrode portion which is not divided,

an interval between the adjacent leading wirings is within a range from 20 to 100 μm,

the first insulating layer is an insulating resin-containing layer having a thickness of 0.5 to 25 μm which is formed on the surfaces of the base layer, the X coordinate detection electrode wiring, the Y coordinate detection electrode wiring, and the leading wirings, through holes exposing a part of the respective independent electrode portions of the X coordinate detection electrode wiring being formed in the first insulating layer,

the jumper lines are formed on the surface of the first insulating layer and in the through holes such that the independent electrode portions constituting the Y direction electrode portion of the respective columns are electrically connected to each other, and

the second insulating layer is formed on the surfaces of the jumper lines and the first insulating layer.

[6] A sensor sheet for a touch pad in which a first electrode sheet and a second electrode sheet are bonded to each other in a laminated state, wherein

the first electrode sheet includes a first base layer, an X coordinate detection electrode wiring, a plurality of first leading wirings, and a third insulating layer, wherein
the X coordinate detection electrode wiring and the first leading wirings are formed on one surface of the first base layer and are respectively formed of a metal deposition layer having a thickness of 0.01 to 1.0 μm,
the X coordinate detection electrode wiring is formed of Y direction electrode portions in a plurality of columns along a Y direction,
an interval between the adjacent first leading wirings is within a range from 20 to 100 μm, and
the third insulating layer is an insulating resin-containing layer having a thickness of 0.5 to 25 μm which is formed on the surfaces of the first base layer, the X coordinate detection electrode wiring, and the first leading wirings; and

the second electrode sheet includes a second base layer, a Y coordinate detection electrode wiring, a plurality of second leading wirings, and a fourth insulating layer, wherein
the Y coordinate detection electrode wiring and the second leading wirings are formed on one surface of the second base layer and are respectively formed of a metal deposition layer having a thickness of 0.01 to 1.0 μm,
the Y coordinate detection electrode wiring is formed of X direction electrode portions in a plurality of columns along a X direction,
an interval between the adjacent second leading wirings is within a range from 20 to 100 μm, and
the fourth insulating layer is an insulating resin-containing layer having a thickness of 0.5 to 25 μm which is formed on the surfaces of the second base layer, the Y coordinate detection electrode wiring, and the second leading.
   [7] A method for manufacturing a sensor sheet for a touch pad, including:

an etching step;

a first insulating layer formation step;

a jumper line printing step; and

a second insulating layer formation step, wherein

in the etching step,
the metal deposition layer of the sensor sheet-producing sheet according to [1] is etched to form an X coordinate detection electrode wiring formed of Y direction electrode portions in a plurality of columns along a Y direction, a Y coordinate detection electrode wiring formed of X direction electrode portions in a plurality of columns along an X direction, and a plurality of leading wirings,
the X coordinate detection electrode wiring is set as a wiring pattern in which the Y direction electrode portions of the respective columns are comprised of an elongated electrode portion which is not divided, and
the Y coordinate detection electrode wiring is set as a wiring pattern in which the X direction electrode portions of the respective columns are comprised of a plurality of independent electrode portions which are divided from each other;

in the first insulating layer formation step,
a first insulating layer is formed by pattern-printing or coating an insulating resin-containing first insulating layer formation ink onto the surfaces of the base layer, the X coordinate detection electrode wiring, the Y coordinate detection electrode wiring, and the leading wirings, so as to form through holes exposing a part of the respective independent electrode portions of the Y coordinate detection electrode wiring;

in the jumper line printing step,
jumper lines are formed on the surface of the first insulating layer and in the through holes such that the independent electrode portions constituting the X direction electrode portions of the respective columns are electrically connected to each other; and

in the second insulating layer formation step,
the second insulating layer is formed by printing or coating an insulating resin-containing second insulating layer formation ink onto the surfaces of the first insulating layer and the jumper lines.
   [8] A method for manufacturing a sensor sheet for a touch pad, including:

an etching step;

a first insulating layer formation step;

a jumper line printing step; and

a second insulating layer formation step, wherein

in the etching step,
the metal deposition layer of the sensor sheet-producing sheet according to [1] is etched to form an X coordinate detection electrode wiring formed of Y direction electrode portions in a plurality of columns along a Y direction, a Y coordinate detection electrode wiring formed of X direction electrode portions in a plurality of columns along an X direction, and a plurality of leading wirings,
the X coordinate detection electrode wiring is set as a wiring pattern in which the Y direction electrode portions of the respective columns are comprised of a plurality of independent electrode portions which are divided from each other, and
the Y coordinate detection electrode wiring is set as a wiring pattern in which the X direction electrode portions of the respective columns are comprised of an elongated electrode portion which is not divided;

in the first insulating layer formation step,
a first insulating layer is formed by pattern-printing or coating an insulating resin-containing first insulating layer formation ink onto the surfaces of the base layer, the X coordinate detection electrode wiring, the Y coordinate detection electrode wiring, and the leading wirings, so as to form through holes exposing a part of the respective independent electrode portions of the X coordinate detection electrode wiring;

in the jumper line printing step,
jumper lines are formed on the surface of the first insulating layer and in the through holes such that the independent electrode portions constituting the Y direction electrode portions of the respective columns are electrically connected to each other; and

in the second insulating layer formation step,
the second insulating layer is formed by printing or coating an insulating resin-containing second insulating layer formation ink onto the surfaces of the first insulating layer and the jumper lines.
   [9] A method for manufacturing a sensor sheet for a touch pad, including:

a first etching step;

a third insulating layer formation step;

a second etching step;

a fourth insulating layer formation step; and

a bonding step, wherein

in the first etching step,
the metal deposition layer of a first sensor sheet-producing sheet formed of the sensor sheet-producing sheet according to [1] is etched to form an X coordinate detection electrode wiring formed of Y direction electrode portions in a plurality of columns along a Y direction and a plurality of first leading wirings,

in the third insulating layer formation step,
a third insulating layer is formed by printing or coating an insulating resin-containing third insulating layer formation ink onto the surfaces of the base layer, the X coordinate detection electrode wiring, and the first leading wirings, to thereby produce a first electrode sheet,

in the second etching step, and
the metal deposition layer of a second sensor sheet-producing sheet formed of the sensor sheet-producing sheet according to [1] is etched to form a Y coordinate detection electrode wiring formed of X direction electrode portions in a plurality of columns along a X direction and a plurality of second leading wirings;

in the fourth insulating layer formation step,
a fourth insulating layer is formed by printing or coating an insulating resin-containing fourth insulating layer formation ink onto the surfaces of the base layer, the Y coordinate detection electrode wiring, and the second leading wirings, to thereby produce a second electrode sheet; and in the bonding step,
the first electrode sheet and the second electrode sheet are bonded to each other in a laminated state.

### Advantageous Effects of Invention

Regarding the sensor sheet-producing sheet of the invention, it is possible to easily narrow the intervals between the leading wirings when forming the leading wirings by etching, bending resistance is high, and cost is low.

According to a method for manufacturing a sensor sheet-producing sheet of the invention, it is possible to easily manufacture a sensor sheet-producing sheet exhibiting the effects described above.

Regarding the sensor sheet for a touch panel of the invention, it is possible to easily narrow the intervals between the leading wirings, bending resistance is high, and cost is low.

According to a method for manufacturing a sensor sheet for a touch panel of the invention, it is possible to easily manufacture a sensor sheet exhibiting the effects described above.

### BRIEF DESCRIPTION OF DRAWINGS

FIG. 1 is a sectional view showing one embodiment of a sensor sheet-producing sheet of the invention.

FIG. 1A is a sectional view showing another embodiment of a sensor sheet-producing sheet of the invention.

FIG. 2 is a plan view showing a first embodiment of a sensor sheet for a touch pad of the invention.

FIG. 3 is a sectional view taken along line I-I′ of FIG. 2.

FIG. 4 is a sectional view showing a second embodiment of a sensor sheet for a touch pad of the invention.

FIG. 5 is a plan view showing a wiring pattern of a first electrode sheet constituting the sensor sheet for a touch pad of FIG. 4.

FIG. 6 is a plan view showing a wiring pattern of a second electrode sheet constituting the sensor sheet for a touch pad of FIG. 4.

### DESCRIPTION OF EMBODIMENTS

### Sensor Sheet-Producing Sheet and Method for Manufacturing Sensor Sheet-Producing Sheet

One embodiment of a sensor sheet-producing sheet of the invention (hereinafter, referred to as a “conductive sheet”) will be described.

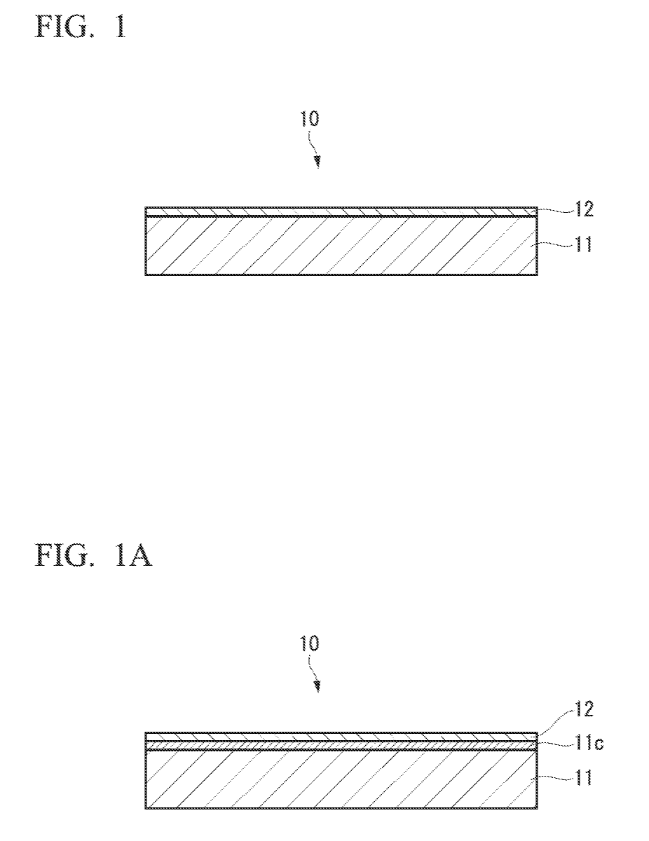

As shown in FIG. 1, a conductive sheet 10 of the embodiment includes a base layer 11 and a metal deposition layer 12 which is formed on one surface of the base layer 11.

In this specification, “conductive properties” mean that an electric resistance value is less than 1 MΩ and “insulating properties” mean that an electric resistance value is equal to or greater than 1 MΩ and preferably equal to or greater than 10 MΩ.

A plastic film can be used as the base layer 11. As resins constituting the plastic film, polyethylene terephthalate, polycarbonate, polyimide, triacetyl cellulose, cyclic polyolefins, acrylic resins, and the like can be used. Among these, polyethylene terephthalate is preferably used, because polyethylene terephthalate has high heat resistance and dimensional stability and causes low cost.

The surface of a layer of the base layer 11 may be subjected to various surface treatments such as a plasma treatment, a ultraviolet irradiation treatment, a corona treatment, and an excimer light treatment. When the surface treatment is performed on the base layer 11 and the metal deposition layer 12 comes into contact with the base layer 11, adhesiveness between the base layer 11 and the metal deposition layer 12 is improved, and when a ground layer which will be described later is formed on the base layer 11, adhesiveness between the base layer and the ground layer is improved. Accordingly, it is possible to prevent peeling of the metal deposition layer 12.

A thickness of the base layer 11 is preferably within a range from 25 to 75 μm. When the thickness of the base layer 11 is equal to or greater than the lower limit value described above, the base layer is difficult to be folded at the time of processing and wrinkles may be generated, and when the thickness thereof is equal to or smaller than the upper limit value described above, a thickness of a touch pad is easily decreased and bending can also be performed. A vertical length and a horizontal length of the base layer 11 are preferably within a range from 2 to 50 cm, respectively.

The metal deposition layer 12 is a metal layer which is formed by a metal deposition method. As metal for forming the metal deposition layer 12, copper, aluminum, nickel, chromium, zinc, gold, and the like can be used. Among these, copper is preferably used, because copper has low electric resistance and causes low cost.

The surface of the metal deposition layer 12 is preferably subjected to a rust prevention treatment by a rust inhibitor, in order to prevent oxidization of the surface thereof. Benzotriazole or the like is used as a rust inhibitor.

A thickness of the metal deposition layer 12 is within a range from 0.01 to 1.00 μm, preferably from 0.05 to 0.30 μm, and more preferably from 0.10 to 0.25 μm. When the thickness of the metal deposition layer 12 is equal to or greater than the lower limit value described above, it is possible to sufficiently decrease electric resistance of the leading wirings and to prevent disconnection due to formation of pinholes. Meanwhile, when the thickness of the metal deposition layer 12 is equal to or smaller than the upper limit value described above, it is possible to prevent fracture of the conductive sheet 10 at the time of bending.

The base layer 11 may include a ground layer 11c on the surface thereof (see FIG. 1A).

Scratches may be formed on the surface of the base layer 11, and when a depth of the scratches is great (specifically, equal to or greater than 0.5 μm), deposited metal may enter the scratches, the thickness of the thin metal deposition layer 12 is difficult to be uniform, and an insulating portion may be partially formed. In addition, in a case of performing chemical etching of the metal deposition layer 12, an etching solution may enter the inner portion of the scratches and the range of the scratches may increase due to corrosion of the base layer 11. However, when the ground layer 11c is provided, it is possible to fill the scratches and to realize a uniform thickness of the metal deposition layer 12. In addition, even in a case of performing chemical etching of the metal deposition layer 12, it is possible to prevent the spread of scratches of the base layer 11.

Resins are used as the material constituting the ground layer 11c, and a material formed by application and curing of a thermosetting resin or an active energy ray curable resin is preferably used. Examples of a thermosetting resin or an active energy ray curable resin include acrylic resins, epoxy resins, urethane resins, urethane acrylic resins, melamine resins, amino resins, phenol resins, and polyester resins. Among these, urethane acrylic resins or melamine resins are preferably used. An organic silane compound, a metal oxide, and the like can be used as the material constituting the ground layer 11c.

A thickness of the ground layer 11c is preferably within a range from 0.1 to 3.0 μm, more preferably from 0.3 to 2.0 μm, and even more preferably from 0.5 to 1.0 μm. When the thickness of the ground layer 11c is equal to or greater than the lower limit value, it is possible to obtain a more uniform thickness of the metal deposition layer 12 and to prevent the spread of scratches of the base layer 11 when chemical etching of the metal deposition layer 12 is performed. However, when the thickness of the ground layer 11c exceeds 3.0 μm, variations in the thickness of the ground layer 11c occur and the ground layer may be broken when the ground layer 11c is deformed together with the base layer 11. A vertical length and a horizontal length of the ground layer 11c are preferably within a range from 2 to 50 cm, respectively. The ground layer 11c is preferably applied to the entire surface of the base layer 11.

The inventors investigated adhesiveness between the base layer and the metal deposition layer and a state of scratches on the surface of the base layer, with respect to the presence or absence of a process regarding the surface treatment of the base layer and the thickness of the ground layer 11c.

A polyethylene terephthalate was used as the base layer and a copper deposition layer (thickness of 0.1 μm) was used as the metal deposition layer. The ground layer 11c was set as a layer of urethane acrylic resins.

Evaluation of adhesiveness was performed based on JIS K5600-5-6 (crosscut method). Specifically, the metal deposition layer was cut into a grid pattern to have 100 squares, and cellophane tape was attached onto the squares and then removed therefrom. The number of squares separated with the cellophane tape was counted and adhesiveness was evaluated based on the following criteria using the number thereof. The results of evaluation are shown in Table 1.

A: The number of squares is smaller than 5.

B: The number of squares is equal to or greater than 5 and smaller than 25.

C: The number of squares is equal to or greater than 25.

The state of scratches on the surface of the base layer was investigated as follows. First, the metal deposition layer was etched to form a circuit pattern having a width of 50 μm and a length of 10 cm and an electric resistance value between both ends of the circuit was measured by a multimeter. The number of measurement samples was 20. Among 20 samples, the number of samples having a circuit resistance value equal to or smaller than 1 kΩ and the state of scratches on the surface of the base layer was evaluated using the numbers thereof. The results of evaluation are shown in Table 1. As the number of samples equal to or smaller than 1 kΩ increases, the number of scratches decreases.

In a comparison between Example 3 and Example 4 and comparison between Example 5 and Example 6, it is found that when a corona surface treatment of the base layer is performed, adhesive is improved. In Example 3 to Example 7, it is found that when the thickness of the ground layer 11c is equal to or greater than 0.1 μm, particularly equal to or greater than 0.5 μm, the number of scratches on the surface of the base layer decreases.

TABLE 1

| | | | Adhesiveness | |
|---|---|---|---|---|
| | | | between | |
| | | Thickness | base layer | State of |
| | corona | of ground | and metal | scratches on |
| | treatment for | layer | deposition | surface of |
| | base layer | (μm) | layer | base layer |
| Example 1 | Not performed | None | C | C |
| Example 2 | Not performed | 0.05 | B | C |
| Example 3 | Not performed | 0.10 | B | B |
| Example 4 | Performed | 0.10 | A | B |
| Example 5 | Not performed | 0.50 | B | A |
| Example 6 | Performed | 0.50 | A | A |
| Example 7 | Performed | 0.80 | A | A |

A method of manufacturing the conductive sheet 10 includes a deposition step in which the metal deposition layer 12 is deposited on one surface of the base layer 11.

The metal deposition method is particularly limited and examples thereof include a plasma CVD method, a laser CVD method, a thermal CVD method, a gas source CVD method, a coating method, a vacuum deposition method, a sputtering method, a reactive sputtering method, a molecular beam epitaxy (MBE) method, a cluster ion beam method, an ion plating method, and a plasma polymerization method (high-frequency excitation ion plating method). Among these, a vacuum deposition method is preferable because a film formation speed and cost thereof are low.

When the vacuum deposition method is applied, a method of adjusting the deposition time by a transportation speed of the base layer 11 when performing deposition of metal is used, as a method of adjusting the thickness of the metal deposition layer 12.

The metal deposition layer 12 formed by deposition of metal is thin. When the thin metal deposition layer 12 is etched to form leading wirings, intervals between the leading wirings can be easily narrowed. In addition, by narrowing the intervals between the leading wirings, the base layer 11 can be efficiently used and the cost of the conductive sheet 10 is decreased due to a small amount of metal used.

Since the metal deposition layer 12 is thin, a difference between deformations of the inner side and the outer side when the conductive sheet 10 is folded is small, and accordingly, bending resistance is increased.

### Sensor Sheet for Touch and Method for Manufacturing Thereof

### First Embodiment

A first embodiment of a sensor sheet for touch pad (hereinafter, abbreviated to a “sensor sheet”) will be described.

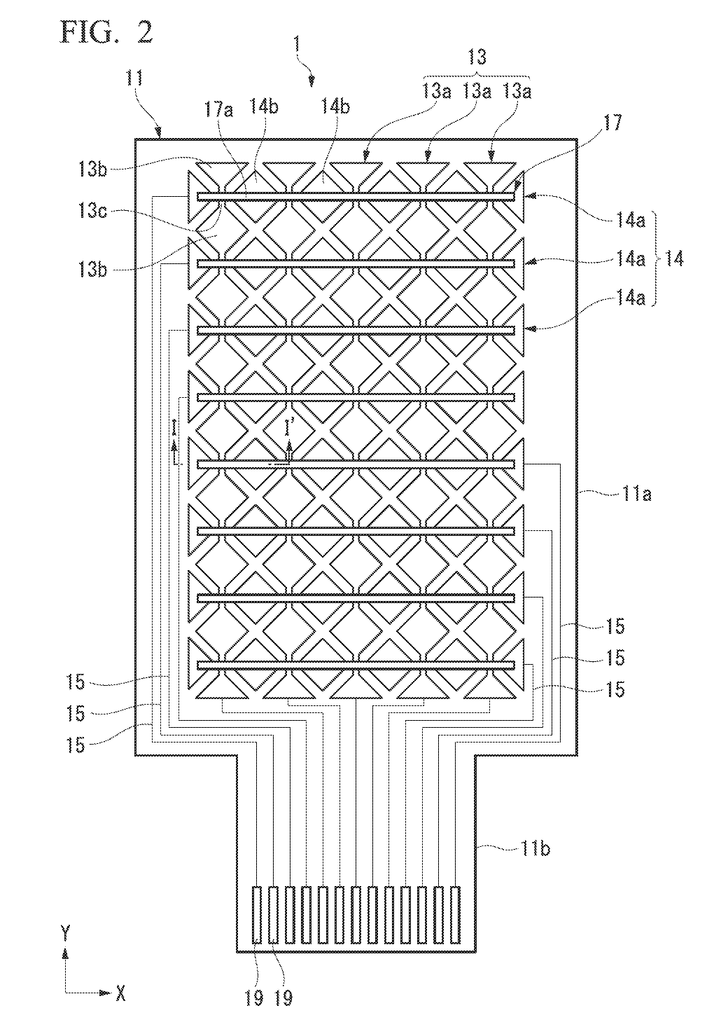

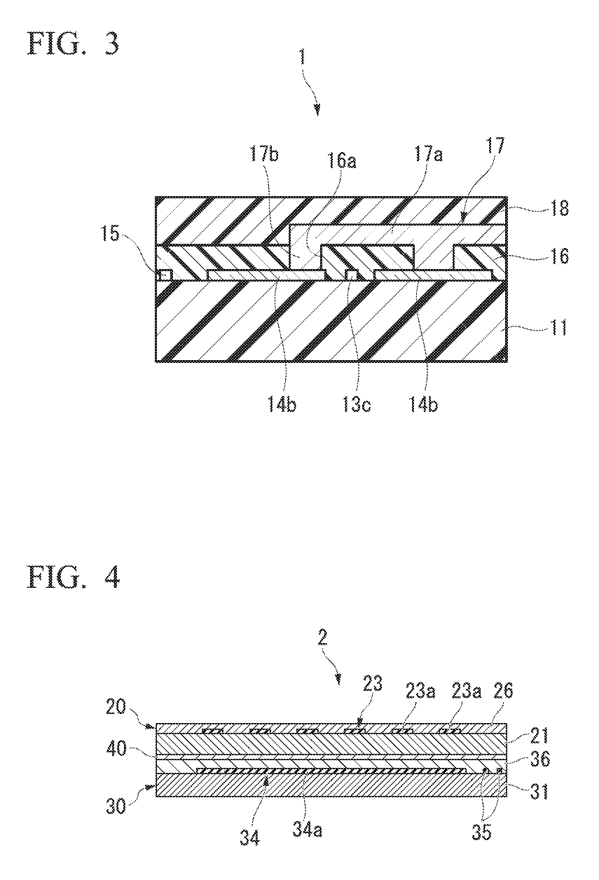

As shown in FIG. 2 and FIG. 3, a sensor sheet 1 of the embodiment is a sheet used for a capacitance touch sensor and includes the base layer 11, an X coordinate detection electrode wiring 13, a Y coordinate detection electrode wiring 14, leading wirings 15, a first insulating layer 16, jumper lines 17, a second insulating layer 18, and terminals for external connection 19.

The base layer 11 is formed of a rectangular electrode formation portion 11a and a rectangular tail portion 11b. A longitudinal direction of the electrode formation portion 11a of the embodiment is along the Y direction. A length of the tail portion 11b of the embodiment in a width direction (X direction) is smaller than a length of the electrode formation portion 11a. The plurality of terminals for external connection 19 are formed on the tail portion 11b.

The X coordinate detection electrode wiring 13, the Y coordinate detection electrode wiring 14, and the leading wirings 15 are conductive wirings formed on one surface of the base layer 11, which respectively have a thickness from 0.01 to 1.0 μm.

The X coordinate detection electrode wiring 13 is formed of Y direction electrode portions 13a, 13a . . . in a plurality of columns and each Y direction electrode portion 13a is formed along the Y direction. Each Y direction electrode portion 13a is formed of triangular or square (for example, rhombus) island-shaped electrode portions 13b, 13b . . . and connection portions 13c, 13c . . . which electrically connect adjacent island-shaped electrode portions 13b and 13b in the Y direction. Each Y direction electrode portion 13a is formed as an elongated electrode portion in which the island-shaped electrode portions 13b and connection portions 13c are not divided but continuously arranged along the Y direction.

The Y coordinate detection electrode wiring 14 is formed of X direction electrode portions 14a, 14a . . . in a plurality of columns. The respective X direction electrode portions 14a are comprised of triangular or square (for example, rhombus) independent electrode portions 14b, 14b . . . which are divided from each other and not electrically connected to each other. The independent electrode portions 14b are formed and arranged along the X direction so as not to come into contact with the Y direction electrode portions 13a.

A length of one side of the island-shaped electrode portions 13b, 13b . . . and the independent electrode portions 14b, 14b . . . having a rhombus shape shown in FIG. 3 is preferably equal to or greater than 1.5 mm and smaller than 6 mm. In addition, a width of the connection portion 13c is preferably the same as a width of the leading wiring 15 which will be described below.

The leading wirings 15 are wirings for connecting each Y direction electrode portion 13a and the terminal for external connection 19 and wirings for connecting each X direction electrode portion 14a and the terminal for external connection 19.

The width of the leading wirings 15 is preferably within a range from 20 to 100 μm and more preferably from 20 to 50 μm. When the width of the leading wirings 15 is equal to or greater than the lower limit value, it is possible to prevent disconnection of the leading wirings, and when the width thereof is equal to or smaller than the lower limit value, it is possible to narrow the width of the outer peripheral portion (frame portion) and to realize lower cost.

An interval between adjacent leading wirings 15 and 15 is within a range from 20 to 100 μm, preferably from 20 to 50 μm, and even more preferably from 20 to 30 μm. It is difficult to set an interval between adjacent leading wirings 15 and 15 to be smaller than the lower limit value. Meanwhile, when an interval between adjacent leading wirings 15 and 15 exceeds the upper limit value, the width of the outer peripheral portion (frame portion) is increased and it is difficult to miniaturize a touch pad.

The first insulating layer 16 is a layer which is formed on the surfaces of the base layer 11, the X coordinate detection electrode wiring 13, the Y coordinate detection electrode wiring 14, and the leading wirings 15 to coat these. The X coordinate detection electrode wiring 13, the Y coordinate detection electrode wiring 14, and the leading wirings 15 are protected by the first insulating layer 16. In addition, electric short circuits between the X coordinate detection electrode wiring 13, the Y coordinate detection electrode wiring 14, and the jumper line 17 are prevented by the first insulating layer 16.

Through holes 16a for exposing a part of each independent electrode portion 14b of the Y coordinate detection electrode wiring 14 are formed on the first insulating layer 16 in a direction perpendicular to the surface of the base layer 11.

Insulating resins are used as resins for forming the first insulating layer 16. As the insulating resins, thermosetting resins or ultraviolet curable resins are used, and ultraviolet curable resins are preferable from a viewpoint of small heat shrinkable properties at the time of curing.

It is preferable that a thickness of the first insulating layer 16 is small in a range for ensuring insulating properties, in order to realize a thin touch pad, and specifically, the thickness thereof is preferably within a range from 0.5 to 25 μm. The first insulating layer 16 is formed by screen printing or ink jet printing as will be described later, and ink jet printing is preferable, in order to realize a thin layer.

When ink jet printing is used, the thickness of the first insulating layer 16 can be set within a range of 0.5 to 5 μm. When screen printing is used, the thickness of the first insulating layer 16 is preferably set within a range of 5 to 25 μm. When the thickness of the first insulating layer 16 is equal to or greater than the lower limit value, formation of pinholes is prevented.

The jumper lines 17 are formed of conductive materials, come into contact with the divided independent electrode portions 14b constituting the X coordinate detection electrode wirings 14a of respective columns, and electrically connect the independent electrode portions 14b, 14b . . . to each other. Each jumper line 17 of the embodiment is formed of a horizontal portion 17a which is formed on the surface of the first insulating layer 16 and a vertical portion 17b which is formed in the through hole 16a. In each jumper line 17, one horizontal portion 17a is linearly formed along the X direction.

As conductive materials for forming the jumper lines 17, a composition containing a resin binder or other additives in metal particles such as silver, copper, or carbon or carbon black, or a sintered body of fine metal particles is used.

A thickness of the jumper line 17 is preferably within a range from 5 to 20 μm. When the thickness of the jumper line 17 is equal to or greater than the lower limit value, it is possible to sufficiently decrease electric resistance of the jumper lines 17, and when the thickness thereof is equal to or smaller than the upper limit value, this can be contributed to realization of the thin sensor sheet 1.

A width of the jumper line 17 is preferably within a range from 0.1 to 1 mm. When the width of the jumper line 17 is equal to or greater than the lower limit value, it is possible to sufficiently decrease electric resistance of the jumper lines 17, and when the width thereof is equal to or smaller than the upper limit value, it is possible to realize lower cost.

The second insulating layer 18 is a layer which coats the jumper lines 17 and the first insulating layer 16 to protect the jumper lines 17. The outermost surface of the second insulating layer 18 is a smooth surface.

The same materials used for the resins for forming the first insulating layer 16 are used as the resins for forming the second insulating layer 18. However, it is not necessary that the resins forming the second insulating layer 18 are the same as the resins for forming the first insulating layer 16.

A thickness of the second insulating layer 18 is preferably within a range from 10 to 25 μm. When the thickness of the second insulating layer 18 is equal to or greater than the lower limit value, it is possible to prevent formation of pinholes and when the thickness thereof is equal to or smaller than the upper limit value, this can be contributed to realization of the thin sensor sheet 1.

The terminals for external connection 19 are terminals for connecting the sheet to an external circuit and are formed of conductive materials. The terminals for external connection 19 of the embodiment are rectangular conductive portions.

In the sensor sheet 1, a surface protection layer may be provided on a front surface side of the second insulating layer 18. Specifically, the surface protection layer may be laminated on the front surface side of the second insulating layer 18 through an adhesive layer.

A glass plate formed of hard aluminosilicate glass or a resin film which is the same as that used for the base layer 11 can be used as the surface protection layer. A hard coat layer may be formed on the surface of the surface protection layer.

A method of manufacturing the sensor sheet 1 described above will be described.

A method of manufacturing the sensor sheet 1 of the embodiment is a method including an etching step, a first insulating layer formation step, a jumper line printing step, a second insulating layer formation step, and a terminal for external connection formation step.

In the etching step, the metal deposition layer 12 (see FIG. 1) of the conductive sheet 10 is etched to form the X coordinate detection electrode wiring 13, the Y coordinate detection electrode wiring 14, and the leading wirings 15 (see FIG. 2).

In the etching step, a wiring pattern of the X coordinate detection electrode wiring 13 is set as a wiring pattern comprised of an elongated electrode portion in which the Y direction electrode portions 13a of each column are formed of the island-shaped electrode portion 13b and the connection portion 13c which are not divided. In addition, a wiring pattern of the Y coordinate detection electrode wiring 14 is set as a wiring pattern comprised of a plurality of independent electrode portions 14b in which X direction electrode portions 14a of each column are divided from each other.

As an etching method, a chemical etching method (wet etching method) or a dry etching method such as laser etching, plasma etching using argon plasma or oxygen plasma, or ion beam etching can be used. Among these, laser etching is preferably used in order to finely form the leading wirings.

An absorption ratio of a laser beam with respect to a wavelength of a laser beam is different depending on the type of metal. Accordingly, in a case of using laser etching, the type of laser beam is suitably selected according to the type of metal used for forming the metal deposition layer.

When metal used for forming the metal deposition layer is copper, a green laser (532 nm) is preferably used as the laser beam used when performing laser etching. Since an absorption ratio of copper with respect to the green laser is equal to or greater than 30%, excellent etching workability is obtained. When the green laser beam is applied, etching can be performed at a scanning speed of 290 mm/s using MD-59920 (YVO₄ laser, wavelength of 532 nm) manufactured by Keyence Corporation.

When metal used for forming the metal deposition layer is copper, a YAG laser (1064 nm) is not preferably used as the laser beam used when performing laser etching. An absorption rate of copper with respect to the YAG laser is equal to or smaller than 10% and etching workability is low.

When metal used for forming the metal deposition layer is aluminum, any of a YAG laser and a green laser can be used as the laser beam when performing laser etching. An absorption rate of copper with respect to both of the YAG laser and green laser is equal to or greater than 20%.

After performing the etching step, various surface treatments such as a plasma treatment, a ultraviolet irradiation treatment, a corona treatment, and an excimer light treatment may be performed on the surfaces of the X coordinate detection electrode wiring 13, the Y coordinate detection electrode wiring 14, and the leading wirings 15. When the surface treatment is performed on the surfaces of the X coordinate detection electrode wiring 13, the Y coordinate detection electrode wiring 14, and the leading wirings 15, wettability with respect to various inks is increased and adhesiveness between the first insulating layer 16, the jumper lines 17, and the terminals for external connection 19 is improved.

The first insulating layer formation step is a step in which the first insulating layer 16 is formed by pattern-printing or coating an insulating resin-containing first insulating layer formation ink onto the surfaces of the base layer 11, the X coordinate detection electrode wiring 13, the Y coordinate detection electrode wiring 14, and the leading wirings 15. In the first insulating layer formation step, the first insulating layer 16 is formed so as to form the through holes 16a exposing a part of the respective independent electrode portions 14b of the Y coordinate detection electrode wiring 14.

As a printing method of the first insulating layer formation ink, screen printing or ink jet printing can be used. Screening printing is preferably used from a viewpoint of a low printing speed, and ink jet printing is preferably used in order to realize the thin first insulating layer 16. The printing of the first insulating layer formation ink may be performed once or plural times. In the invention, the printing can be performed once, so as to realize the thin first insulating layer 16.

After the printing, drying is performed as necessary. After that, when a thermosetting resin is used as an insulating resin, the printed ink is heated to be cured, and when an ultraviolet curable resin is used as an insulating resin, the printed ink is irradiated with ultraviolet beams and the ink is cured.

The jumper line printing step is a step in which the jumper lines 17 are formed on the surface of the first insulating layer 16 and in the through holes 16a such that the independent electrode portions 14b, 14b . . . constituting the X direction electrode portions 14a of the respective columns are electrically connected to each other.

As a printing method of the jumper lines 17, a method of performing screen printing of a conductive paste is preferably used, in order to easily form the jumper lines 17.

As a conductive paste, a silver paste, a copper paste, or a carbon paste can be used.

After printing the conductive paste, it is preferable that the printed conductive paste is heated to be cured.

The second insulating layer formation step is a step in which the second insulating layer 18 is formed by printing or coating an insulating resin-containing second insulating layer formation ink onto the surfaces of the first insulating layer 16 and the jumper lines 17.

As a printing method used in the second insulating layer formation step, screen printing or ink jet printing can be used, in the same manner as in the first insulating layer formation step. In addition, as a coating method used in the second insulating layer formation step, various coating methods such as a die coating method, a roll coating method, and a bar coating method can be used.

The terminal for external connection formation step is a step in which the terminals for external connection 19 connected to the leading wirings 15 is formed on the surface of the base layer 11. As a method of forming the terminals for external connection 19, a method of performing screen printing of a conductive paste is used.

The terminal for external connection formation step can be performed before or after any step described above.

In the sensor sheet 1, the leading wirings 15 are formed using the conductive sheet 10, and an interval between the leading wirings 15 and 15 can be easily narrowed. In the same manner as in the conductive sheet 10, the base layer 11 is efficiently used and the cost of the sensor sheet 1 is decreased due to a small amount of metal used. The sensor sheet 1 obtained by using the conductive sheet 10 has high bending resistance.

In addition, in the sensor sheet 1 obtained by using the conductive sheet 10, the X coordinate detection electrode wiring 13, the Y coordinate detection electrode wiring 14, and the leading wirings 15 are thin, and accordingly, even when the first insulating layer 16 is thin, the X coordinate detection electrode wiring 13, the Y coordinate detection electrode wiring 14, and the leading wirings 15 are sufficiently coated to obtain insulating properties. Therefore, it is possible to easily realize the thin sensor sheet 1. When the first insulating layer 16 is not thin, it is possible to easily fill the inside of the through holes 16a with the conductive paste in the jumper line formation step and to prevent connection failure between the independent electrode portions 14b and the jumper lines 17.

### Second Embodiment

A second embodiment of a sensor sheet will be described.

As shown in FIG. 4, a sensor sheet 2 of the embodiment is a sheet used for a capacitance touch sensor and is a sheet in which a first electrode sheet 20 and a second electrode sheet 30 are bonded to each other in a laminated state. The first electrode sheet 20 is disposed on a front surface side with respect to the second electrode sheet 30.

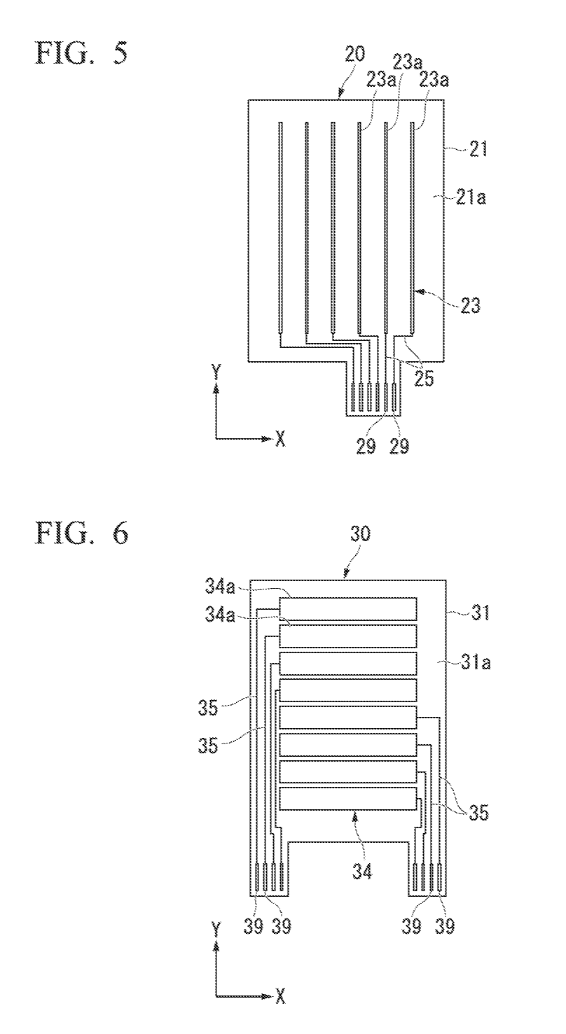

The first electrode sheet 20 includes a first base layer 21, an X coordinate detection electrode wiring 23, a plurality of first leading wirings 25, a third insulating layer 26, and terminals for external connection 29 (see FIG. 4 and FIG. 5).

The second electrode sheet 30 includes a second base layer 31, a Y coordinate detection electrode wiring 34, a plurality of second leading wirings 35, a fourth insulating layer 36, and terminals for external connection 39 (see FIG. 4 and FIG. 6).

As shown in FIG. 5, in the first electrode sheet 20, the X coordinate detection electrode wiring 23 and the first leading wirings 25 are formed on one surface 21a of the first base layer 21 and are respectively formed of a metal deposition layer having a thickness of 0.01 to 1.00 μm. A thickness of the metal deposition layer is preferably within a range from 0.05 to 0.30 μm and more preferably from 0.10 to 0.25 μm.

As a material constituting the first base layer 21, the same material as that used for the base layer 11 can be used.

The X coordinate detection electrode wiring 23 of the embodiment is formed of Y direction electrode portions 23a, 23a . . . in a plurality of columns and each Y direction electrode portion 23a is formed along the Y direction. Each Y direction electrode portion 23a of the embodiment is a band electrode portion having a constant width. As a material constituting the X coordinate detection electrode wiring 23, the same material as that used for the X coordinate detection electrode wiring 13 can be used.

The first leading wirings 25 are wirings for connecting each Y direction electrode portion 23a and the terminal for external connection 29. As a material constituting the first leading wirings 25, the same material as that used for the leading wirings 15 can be used.

A width of the first leading wirings 25 and an interval between adjacent first leading wirings 25 and 25 are the same as the width of the leading wirings 15 and the interval between adjacent leading wirings 15 and 15 of the first embodiment.

The third insulating layer 26 is a layer which is formed on the surfaces of the first base layer 21, the X coordinate detection electrode wiring 23, and the first leading wirings 25 to coat these. The X coordinate detection electrode wiring 23 is coated with and protected by the third insulating layer 26. The outermost surface of the third insulating layer 26 is a smooth surface.

The same materials used for the resins for forming the first insulating layer 16 are used as the resins for forming the third insulating layer 26.

A thickness of the third insulating layer 26 is within a range from 0.5 to 25 μm. When ink jet printing is used in the formation of the third insulating layer 26, the thickness of the third insulating layer 26 is preferably within a range of 0.5 to 5 μm. When screen printing is used in the formation of the third insulating layer 26, the thickness of the third insulating layer 26 is preferably within a range of 5 to 25 μm. When the thickness of the third insulating layer 26 is equal to or greater than the lower limit value, formation of pinholes is prevented.

The terminals for external connection 29 are terminals for connecting the sheet to an external circuit and are formed of conductive materials. The terminals for external connection 29 of the embodiment are rectangular conductive portions.

The same material used for the terminals for external connection 19 can be used as the material constituting the terminals for external connection 29.

As shown in FIG. 6, in the second electrode sheet 30, the Y coordinate detection electrode wiring 34 and the second leading wirings 35 are formed on one surface 31a of the second base layer 31 and are respectively formed of a metal deposition layer having a thickness of 0.01 to 1.00 μm. A thickness of the metal deposition layer is preferably within a range from 0.05 to 0.30 μm and more preferably from 0.10 to 0.25 μm.

As a material constituting the second base layer 31, the same material as that used for the base layer 11 can be used.

The Y coordinate detection electrode wiring 34 of the embodiment is formed of X direction electrode portions 34a, 34a . . . in a plurality of columns and each X direction electrode portion 34a is formed along the X direction. Each X direction electrode portion 34a of the embodiment is a band electrode portion having a constant width. As a material constituting the Y coordinate detection electrode wiring 34, the same material as that used for the Y coordinate detection electrode wiring 14 can be used.

The second leading wirings 35 are wirings for connecting each X direction electrode portion 34a and the terminal for external connection 39. As a material constituting the second leading wirings 35, the same material as that used for the leading wirings 15 can be used.

A width of the second leading wirings 35 and an interval between adjacent second leading wirings 35 and 35 are the same as the width of the leading wirings 15 and the interval between adjacent leading wirings 15 and 15 of the first embodiment.

The fourth insulating layer 36 is a layer which is formed on the surfaces of the second base layer 31, the Y coordinate detection electrode wiring 34, and the second leading wirings 35 to coat these. The Y coordinate detection electrode wiring 34 is coated with and protected by the fourth insulating layer 36. The outermost surface of the fourth insulating layer 36 is a smooth surface.

The same materials used for the resins for forming the first insulating layer 16 are used as the resins for forming the fourth insulating layer 36.

A thickness of the fourth insulating layer 36 is within a range from 0.5 to 25 μm. When ink jet printing is used in the formation of the fourth insulating layer 36, the thickness of the fourth insulating layer 36 is preferably within a range of 0.5 to 5 μm. When screen printing is used in the formation of the fourth insulating layer 36, the thickness of the fourth insulating layer 36 is preferably within a range of 5 to 25 μm. When the thickness of the fourth insulating layer 36 is equal to or greater than the lower limit value, formation of pinholes is prevented.

The terminals for external connection 39 are terminals for connecting the sheet to an external circuit and are formed of conductive materials. The terminals for external connection 39 of the embodiment are rectangular conductive portions.

The same material used for the terminals for external connection 19 can be used as the material constituting the terminals for external connection 39.

The first electrode sheet 20 and the second electrode sheet 30 are bonded to each other through an adhesive layer 40. The adhesive layer 40 of the embodiment is formed so as to bond the first base layer 21 of the first electrode sheet 20 and the fourth insulating layer 36 of the second electrode sheet 30 to each other.

Since it is necessary that the sensor sheet 2 be used for a capacitance touch sensor, the adhesive layer is also set to be transparent.

The adhesive layer 40 may be an adhesive tape and may be a layer formed by application of an adhesive or a pressure sensitive adhesive. A hot-melt adhesive can be used as the adhesive.

In the sensor sheet 2, a surface protection layer may be provided on a front surface side of the first electrode sheet 20. Specifically, the surface protection layer may be laminated on the third insulating layer 26 through an adhesive layer.

The same material used for the surface protection layer which may be used in the sensor sheet 1 is used as the surface protection layer.

A method for manufacturing the sensor sheet 2 will be described.

The method for manufacturing the sensor sheet 2 of the embodiment includes a first etching step, a third insulating layer formation step, a first terminal for external connection formation step, a second etching step, a fourth insulating layer formation step, a second terminal for external connection formation step, and a bonding step.

In the first etching step, the metal deposition layer 12 (see FIG. 1) of the conductive sheet 10 is etched to form the X coordinate detection electrode wiring 23 and the first leading wirings 25 (see FIG. 5). In the first etching step, a wiring pattern of the X coordinate detection electrode wiring 23 is set as a wiring pattern in which the Y direction electrode portion 23a of each column is set as a band electrode portion having a constant width along the Y direction.

An etching method and etching conditions in the first etching step are the same as those in the etching step of the first embodiment.

The third insulating layer formation step is a step in which the third insulating layer 26 is formed by pattern-printing or coating an insulating resin-containing third insulating layer formation ink onto the surfaces of the first base layer 21, the X coordinate detection electrode wiring 23, and the first leading wirings 25.

As a printing method of the third insulating layer formation ink, screen printing or ink jet printing can be used.

The first terminal for external connection formation step is a step in which the terminals for external connection 29 connected to the first leading wirings 25 is formed on the surface of the first base layer 21. As a method of forming the terminals for external connection 29, a method of performing screen printing of a conductive paste is used.

In the second etching step, the metal deposition layer 12 (see FIG. 1) of the conductive sheet 10 is etched to form the Y coordinate detection electrode wiring 34 and the second leading wirings 35 (see FIG. 6). In the second etching step, a wiring pattern of the Y coordinate detection electrode wiring 34 is set as a wiring pattern in which the X direction electrode portion 34a of each column is set as a band electrode portion having a constant width along the X direction.

An etching method and etching conditions in the second etching step are the same as those in the etching step of the first embodiment.

The fourth insulating layer formation step is a step in which the fourth insulating layer 36 is formed by pattern-printing or coating an insulating resin-containing fourth insulating layer formation ink onto the surfaces of the second base layer 31, the Y coordinate detection electrode wiring 34, and the second leading wirings 35.

As a printing method of the fourth insulating layer formation ink, screen printing or ink jet printing can be used.

The second terminal for external connection formation step is a step in which the terminals for external connection 39 connected to the second leading wirings 35 is formed on the surface of the second base layer 31. As a method of forming the terminals for external connection 39, a method of performing screen printing of a conductive paste is used.

In the bonding step, the first electrode sheet 20 and the second electrode sheet 30 are bonded to each other through the adhesive layer 40. In the bonding step of the embodiment, the first base layer 21 of the first electrode sheet 20 and the fourth insulating layer 36 of the second electrode sheet 30 are bonded to each other through the adhesive layer 40. Through this bonding step, the sensor sheet 2 is obtained.

In the sensor sheet 2, the first leading wirings 25 are formed on the first electrode sheet 20 using the conductive sheet 10, and accordingly, it is possible to easily narrow the intervals between the first leading wirings 25 and 25. In addition, since the second leading wirings 35 are formed on the second electrode sheet 30 using the conductive sheet 10, it is possible to easily narrow the intervals between the second leading wirings 35 and 35. Further, the sensor sheet 2 obtained by using the conductive sheet 10 has high bending resistance.

In the first electrode sheet 20 constituting the sensor sheet 2, the X coordinate detection electrode wiring 23 and the first leading wirings 25 are thin, and accordingly, even when the third insulating layer 26 is thin, it is possible to sufficiently coat the X coordinate detection electrode wiring 23 and the first leading wirings 25. In the second electrode sheet 30 constituting the sensor sheet 2, the Y coordinate detection electrode wiring 34 and the second leading wirings 35 are thin, and accordingly, even when the fourth insulating layer 36 is thin, it is possible to sufficiently coat the Y coordinate detection electrode wiring 34 and the second leading wirings 35. Therefore, it is possible to easily realize the thin sensor sheet 2.

In addition, the sensor sheet 2 in which the first electrode sheet 20 and the second electrode sheet 30 are bonded to each other has a simple structure without forming jumper lines and the like, therefore, the sensor sheet can be easily manufactured and cost thereof is low.

### Other Embodiments

The invention is not limited to the embodiments described above.

In the first embodiment, it is not necessary that the jumper lines which electrically connect the independent electrode portions of each X direction electrode portion include one continuous horizontal portion, and the jumper lines in which horizontal portions are provided in every interval between adjacent independent electrode portions may be provided. When the jumper lines in which horizontal portions are provided in every interval between adjacent independent electrode portions is provided, it is possible to decrease an amount of conductive materials used.

In addition, it is not necessary that the independent electrode portions of the X direction electrode portion and the island-shaped electrode portions of the Y direction electrode portions are triangular or square, and an arbitrary shape can be used, and for example, a semispherical or a circular shape may be used. In addition, the X direction electrode portion and the Y direction electrode portion may be a band shape having a constant width.

In the first embodiment, the Y direction electrode portions are comprised of an elongated electrode portion and the X direction electrode portions are comprised of a plurality of divided independent electrode portions, but the X direction electrode portions may be comprised of an elongated electrode portion and the Y direction electrode portions may be comprised of a plurality of divided independent electrode portions. In this case, the plurality of divided independent electrode portions of each Y direction electrode portion are electrically connected by the jumper line.

A sensor sheet in which the Y direction electrode portions are comprised of an elongated electrode portion and the X direction electrode portions are comprised of a plurality of divided independent electrode portions, can be manufactured by the method for manufacturing the sensor sheet described above, except for switching X and Y of the X direction electrode portions and the Y direction electrode portions.

In the second embodiment, it is not necessary that electrode portions having a constant width are formed in a plurality of columns in the wiring pattern of the X coordinate detection electrode wiring and the wiring pattern of the Y coordinate detection electrode wiring, and a well-known electrode wiring pattern of a capacitance sensor sheet can be used without any limitation.

### REFERENCE SIGNS LIST

1,2 Sensor sheet
10 Conductive sheet
11 Base layer
11a Electrode formation portion
11b Tail portion
11c Ground layer
12 Metal deposition layer
13 X coordinate detection electrode wiring
13a Y direction electrode portion
13b Island-shaped electrode portion
13c Connection portion
14 Y coordinate detection electrode wiring
14a X Direction electrode portion
14b Independent electrode portion
15 Leading wiring
16 First insulating layer
16a Through holes
17 Jumper line
17a Horizontal portion
17b Vertical portion
18 Second insulating layer
19 Terminal for external connection
20 First electrode sheet
21 First base layer
23 X coordinate detection electrode wiring
23a Y direction electrode portion
25 First leading wiring
26 Third insulating layer
29 Terminal for external connection
30 Second electrode sheet
31 Second base layer
34 Y coordinate detection electrode wiring
34a X direction electrode portion
35 Second leading wiring
36 Fourth insulating layer
39 Terminal for external connection
40 Adhesive layer

1. A sensor sheet-producing sheet comprising:
a base layer; and
a metal deposition layer having a thickness of 0.01 to 1.0 μm which is formed on one surface of the base layer.

2. A method for manufacturing a sensor sheet-producing sheet, comprising: a deposition step in which a metal deposition layer having a thickness of 0.01 to 1.0 μm is deposited on one surface of a base layer.

3. The method for manufacturing a sensor sheet-producing sheet according to claim 2, wherein the deposition is vacuum deposition.

4. A sensor sheet for a touch pad comprising:
a base layer;
an X coordinate detection electrode wiring;
a Y coordinate detection electrode wiring;
a plurality of leading wirings;
a first insulating layer;
jumper lines; and
a second insulating layer, wherein
the X coordinate detection electrode wiring, the Y coordinate detection electrode wiring, and the leading wirings are formed on one surface of the base layer and are respectively formed of a metal deposition layer having a thickness of 0.01 to 1.0 μm,
the X coordinate detection electrode wiring/the Y coordinate detection electrode wiring has a wiring pattern which is formed of Y direction electrode portions/X direction electrode portions in a plurality of columns along a Y direction/an X direction and in which the Y direction electrode portions/the X direction electrode portions of the respective columns are comprised of an elongated electrode portion which is not divided,
the Y coordinate detection electrode wiring/the X coordinate detection electrode wiring has a wiring pattern which is formed of X direction electrode portions/Y direction electrode portions in a plurality of columns along the X direction/the Y direction and in which the X direction electrode portions/the Y direction electrode portions of the respective columns are comprised of a plurality of independent electrode portions which are divided from each other,
an interval between the adjacent leading wirings is within a range from 20 to 100 μm,
the first insulating layer is an insulating resin-containing layer having a thickness of 0.5 to 25 μm which is formed on the surfaces of the base layer, the X coordinate detection electrode wiring, the Y coordinate detection electrode wiring, and the leading wirings, through holes exposing a part of the respective independent electrode portions of the Y coordinate detection electrode wiring/the X coordinate detection electrode wiring being formed in the first insulating layer,
the jumper lines are formed on the surface of the first insulating layer and in the through holes such that the independent electrode portions constituting the X direction electrode portion/the Y direction electrode portion of the respective columns are electrically connected to each other, and
the second insulating layer is formed on the surfaces of the jumper lines and the first insulating layer.

5. A sensor sheet for a touch pad in which a first electrode sheet and a second electrode sheet are bonded to each other in a laminated state, wherein
the first electrode sheet comprises a first base layer, an X coordinate detection electrode wiring, a plurality of first leading wirings, and a third insulating layer, wherein
the X coordinate detection electrode wiring and the first leading wirings are formed on one surface of the first base layer and are respectively formed of a metal deposition layer having a thickness of 0.01 to 1.0 μm,
the X coordinate detection electrode wiring is formed of Y direction electrode portions in a plurality of columns along a Y direction,
an interval between the adjacent first leading wirings is within a range from 20 to 100 μm, and
the third insulating layer is an insulating resin-containing layer having a thickness of 0.5 to 25 μm which is formed on the surfaces of the first base layer, the X coordinate detection electrode wiring, and the first leading wirings; and
the second electrode sheet includes a second base layer, a Y coordinate detection electrode wiring, a plurality of second leading wirings, and a fourth insulating layer, wherein
the Y coordinate detection electrode wiring and the second leading wirings are formed on one surface of the second base layer and are respectively formed of a metal deposition layer having a thickness of 0.01 to 1.0 μm,
the Y coordinate detection electrode wiring is formed of X direction electrode portions in a plurality of columns along a X direction,
an interval between the adjacent second leading wirings is within a range from 20 to 100 μm, and
the fourth insulating layer is an insulating resin-containing layer having a thickness of 0.5 to 25 μm which is formed on the surfaces of the second base layer, the Y coordinate detection electrode wiring, and the second leading.

6. A method for manufacturing a sensor sheet for a touch pad using the sensor sheet-producing sheet according to claim 1, the method comprising:
an etching step;
a first insulating layer formation step;
a jumper line printing step; and
a second insulating layer formation step, wherein
in the etching step,
the metal deposition layer of the sensor sheet-producing sheet is etched to form an X coordinate detection electrode wiring formed of Y direction electrode portions in a plurality of columns along a Y direction, a Y coordinate detection electrode wiring formed of X direction electrode portions in a plurality of columns along an X direction, and a plurality of leading wirings,
the X coordinate detection electrode wiring/the Y coordinate detection electrode wiring is set as a wiring pattern in which the Y direction electrode portions/the X direction electrode portions of the respective columns are comprised of an elongated electrode portion which is not divided, and
the Y coordinate detection electrode wiring/the X coordinate detection electrode wiring is set as a wiring pattern in which the X direction electrode portions/the Y direction electrode portions of the respective columns are comprised of a plurality of independent electrode portions which are divided from each other;
in the first insulating layer formation step,
a first insulating layer is formed by pattern-printing or coating an insulating resin-containing first insulating layer formation ink onto the surfaces of the base layer, the X coordinate detection electrode wiring, the Y coordinate detection electrode wiring, and the leading wirings, so as to form through holes exposing a part of the respective independent electrode portions of the Y coordinate detection electrode wiring/the X coordinate detection electrode wiring;
in the jumper line printing step,
jumper lines are formed on the surface of the first insulating layer and in the through holes such that the independent electrode portions constituting the X direction electrode portions/the Y direction electrode portions of the respective columns are electrically connected to each other; and
in the second insulating layer formation step,
the second insulating layer is formed by printing or coating an insulating resin-containing second insulating layer formation ink onto the surfaces of the first insulating layer and the jumper lines.

7. A method for manufacturing a sensor sheet for a touch pad using the sensor sheet-producing sheet according to claim 1, the method comprising:
a first etching step;
a third insulating layer formation step;
a second etching step;
a fourth insulating layer formation step; and
a bonding step, wherein
in the first etching step,
the metal deposition layer of a first sensor sheet-producing sheet formed of the sensor sheet-producing sheet is etched to form an X coordinate detection electrode wiring formed of Y direction electrode portions in a plurality of columns along a Y direction and a plurality of first leading wirings,
in the third insulating layer formation step,
a third insulating layer is formed by printing or coating an insulating resin-containing third insulating layer formation ink onto the surfaces of the base layer, the X coordinate detection electrode wiring, and the first leading wirings, to thereby produce a first electrode sheet,
in the second etching step, and
the metal deposition layer of a second sensor sheet-producing sheet formed of the sensor sheet-producing sheet according to claim 1 is etched to form a Y coordinate detection electrode wiring formed of X direction electrode portions in a plurality of columns along a X direction and a plurality of second leading wirings;
in the fourth insulating layer formation step,
a fourth insulating layer is formed by printing or coating an insulating resin-containing fourth insulating layer formation ink onto the surfaces of the base layer, the Y coordinate detection electrode wiring, and the second leading wirings, to thereby produce a second electrode sheet; and
in the bonding step,
the first electrode sheet and the second electrode sheet are bonded to each other in a laminated state.
